(19) United States
(12) Patent Application Publication
(10) Pub. No.: US 2015/0106526 A1
(43) Pub. Date: Apr. 16, 2015

(54) PROVISIONING A NETWORK FOR NETWORK TRAFFIC

(71) Applicant: HEWLETT-PACKARD DEVELOPMENT COMPANY, L.P, Houston, TX (US)

(72) Inventor: Manfred R. Arndt, Folsom, CA (US)

(73) Assignee: HEWLETT-PACKARD DEVELOPMENT COMPANY, L.P, Houston, TX (US)

(21) Appl. No.: 14/052,082

(22) Filed: Oct. 11, 2013

(51) Int. Cl. H04L 29/06

(52) U.S. Cl. CPC H04L 65/1069
USPC 709/227

(57) ABSTRACT

A network system comprising a software-defined network (SDN) controller and an application program interface (API) communicatively coupled to an application and the SDN controller in which data is provided from the API to the SDN controller, the data comprising information regarding the application session characteristics associated with a new session to be initiated on the network. A method of provisioning a network for network traffic comprising receiving data at a software-defined network (SDN) controller from an application program interface (API) describing application information associated with a session to be initiated on the network from an end-point device associated with a number of nodes in the network, and providing the API with real-time data describing available bandwidth on the network that the application may use.

### BACKGROUND

Unified Communications (UC) is the integration of a number of communication services over a network connection such as an internet, an intranet, or the Internet. These communication services may comprise instant messaging, telephony, audio conferencing, video conferencing, emailing, and desktop sharing, among others. Each of these services implements a number of applications in order to send data through the network. Additionally, each service uses a portion of the network bandwidth to deliver the information over the network.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a network according to one example of the principles described herein.

FIG. 2 is a block diagram showing a software-defined network system according to one example of the principles described herein.

FIG. 3 is a flowchart showing a method of provisioning a network for network traffic according to one example of principles described herein.

Throughout the drawings, identical reference numbers designate similar, but not necessarily identical, elements.

### DETAILED DESCRIPTION

As described above, each communication service may be implemented over a network connection having a physical bandwidth limitation. This results in all data being sent from a network having to share the available bandwidth.

If all the data sent out from the network was non-latency-sensitive data, a switch may simply buffer the data packets as they are received and then send those data packets out from the network as bandwidth is available according to a “best effort” policy. To the users involved with this process, the latency or packet loss, due to heavy network traffic from the buffering of a number of packets or from packet loss due to all switch buffers in use while receiving or sending out packets may even be unnoticeable in this situation. However, when latency-sensitive types of data services such as interactive voice or video conferencing are being used over the network, heavy traffic or congestion in a network may cause audio and/or video quality degradation which is noticeable to a user. Heavy traffic comprising non-latency-sensitive packets and latency-sensitive packets may result in a bottleneck forming on a network connection and creating a reduction in the quality of experience (QoE) for the user.

As traffic is forwarded across the network, each data packet sent comprises a packet header. In an attempt to overcome network traffic bottlenecks described above for latency-sensitive packets, some network administrators have implemented a brute force method to improve the QoE. The brute force method leverages the user datagram protocol (UDP), or transmission control protocol (TCP) packet headers of each data packet transmitted. A source and destination port number may be designated within these headers by the individual applications and, via an application server, a certain range of port numbers may be assigned to the header of a specific type of network traffic. Alternatively, a source IP address or destination IP address within the header may be used to identify the type of network traffic, or combinations thereof. In some examples, the type of network traffic may be application specific while in other examples, the type of network traffic may be generally defined such that voice data packets, video data packets, and other types of data packets may have their headers designate a type of data by assigning them a specific range of ports.

As each packet enters the network, an access switch may determine the port number range or IP addresses using deep packet inspection (DPI). The discovered port number or IP addresses may be compared with an access control list (ACL) at the access switch to determine what type of data is in the payload and enforce the policies associated with the ACL. Consequently, some latency-sensitive data may be given preferential treatment over other non-latency-sensitive data. The packets may be marked by rewriting the packet priority at the edge of the client network or some other network boundary or be implemented at each switch in the network. In one example, the layer 2 header priority may be modified to reflect the queuing priority. In another example, the layer 3 differentiated service code point (DSCP) may be modified. The brute force method, however, requires that static policies match application server settings or some other static identifiable attribute within the packet header. Additionally, the brute force method may not react appropriately to topology changes, radio frequency (RF) interference, varying link capacity, congestion, among other dynamic changes in the network.

Another solution may be to have each end-point computing device appropriately mark the packet priority itself, in its header, before sending the packet out. This, however, is not a desirable option for a user and some end-point devices such as smartphones are consumer oriented and may not support this capability to change the quality of service (QoS) settings. Still further, if a user is responsible for manually updating the QoS on his or her device for a specific application, all other device users may do the same and a situation may begin to exist where all applications on all end-point devices have the maximum QoS settings, thereby creating the same problem as before with each end-point device and applications being equally treated. In order to prevent this from happening, a network administrator may configure the access switch to ignore the QoS settings assigned by the end-point in the packet header. A trust boundary may be created where the network administrator by default modifies the packet header priority to “best effort” and only increase the priority for selected types of latency-sensitive data packets.

The present specification, therefore describes a network system comprising a software-defined network (SDN) controller and an application program interface (API) communicatively coupled to an application and the SDN controller in which data is provided from the API to the SDN controller, the data comprising information regarding the specific user's application session characteristics associated with a new session to be initiated on the network.

The present specification further describes a method of provisioning a network for network traffic comprising receiving data at a software-defined network (SDN) controller from an application program interface (API) describing application specific information associated with a session to be initiated on the network from an end-point device associated with a number of nodes in the network, and providing the API with real-time data describing available bandwidth on the network that the application may use.

Still further, the present specification describes a computer program product for provisioning a network for network traffic, the computer program product comprising a computer readable storage medium comprising computer usable program code embodied therewith, the computer usable program code comprising computer usable program code to, when executed by a processor, receive data at a software-defined network (SDN) controller from an application program interface (API) describing application information associated with a session to be initiated on the network from an end-point device associated with a number of nodes in the network, and computer usable program code to, when executed by a processor, provide the API with real-time data describing available bandwidth on the network that the application may use.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “session” is meant to be understood broadly as runtime instance of a voice call, video conferencing application, desktop sharing, interactive gaming, or any other application that would benefit from low latency traffic or other preferential QoS policy treatment. In some examples, the sessions may be the transmission of data packets on a network comprising voice, video, data, or combinations thereof.

Additionally, in the present specification and in the appended claims, the term “best effort” is meant to be understood broadly as any type of default QoS service all traffic on a network receives by default and which is subjected to all remaining bandwidth available on a network connection and/or remaining buffer resources available within switches along the path, after all QoS policies have been applied to the preferential traffic on a network connection.

Further, in the present specification and in the appended claims, the term “node” is meant to be understood broadly as any connection point within a network. In some examples, a node may be a network switch that communicatively links network segments or network devices within the network. In other examples, a node may be a router that forwards data packets between networks. In a different example, a node may be a firewall or other security device within the network. In yet another example, a node may be a wireless access point that communicatively links network devices wirelessly with the network.

Even further, as used in the present specification and in the appended claims, the term “a number of” or similar language is meant to be understood broadly as any positive number comprising 1 to infinity; zero not being a number, but the absence of a number.

In the present specification and in the appended claims the term “network” is meant to be understood broadly as any combination of hardware and software that includes a number of switches, routers or wireless access points, and instructions processed by the switches, routers and wireless access points to define the forwarding behavior of data packets.

Further, as used in the present specification and in the appended claims, the term “switch” or “router” is meant to be understood broadly as any connection point within a network and can apply equally to a WAN router, wireless access point, firewall, security device, or any other networking device.

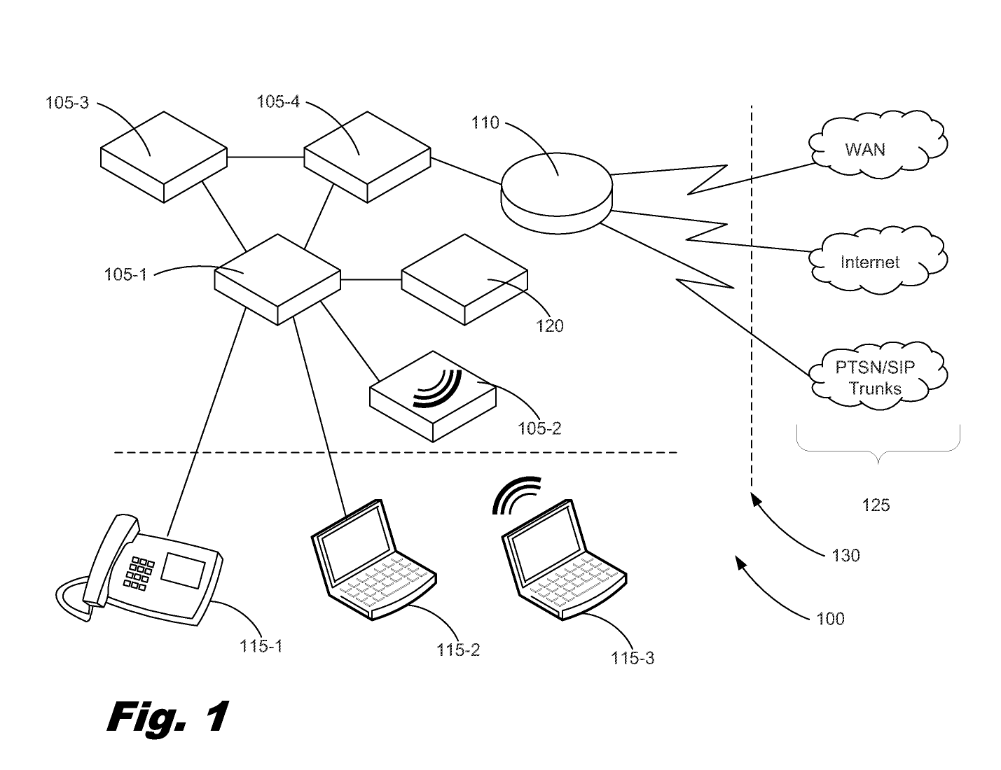

FIG. 1 is a block diagram of a network (100) according to one example of the principles described herein. The network (100) may comprise a number of switches (105-1, 105-2, 105-3, 105-4), a router (110), an SDN controller (120), and a number of end-points (115-1, 115-2, 115-3) communicatively coupled to the network (100). The network (100) may be a local area network (LAN), a wide area network (WAN), a personal area network (PAN), a campus area network (CAN), a metropolitan area network (MAN), or combinations thereof. The network may further comprise any number of routers (110), switches (105-1, 105-2, 105-3, 105-4), end-point devices (115-1, 115-2, 115-3) each communicatively coupled to each other via either a wired connection or wireless connection. The example shown in FIG. 1 is merely meant to be presented as an example and is not meant to be limiting on the size or type of network (100) on which the present system and method may operate on.

Each switch (105-1, 105-2, 105-3, 105-4) may comprise any type of networking device that links network segments or network devices together. Additionally, each switch may comprise computer readable program code embodied on a computer readable media that receives, processes, and forwards or routes data to and from devices within the network (100). In one example, each switch (105-1, 105-2, 105-3, 105-4) may be controlled by a software-defined network (SDN) controller (120) in a software-defined network (SDN). Consequently, the decision as to where traffic is sent may not be determined solely by the individual switches (105-1, 105-2, 105-3, 105-4), but instead may be centralized in a single SDN controller (120). Again, although FIG. 1 shows a single SDN controller (120), this is merely meant as an example and the present application contemplates the use of a number of SDN controllers (120) that may control a number of switches (105-1, 105-2, 105-3, 105-4) with another SDN controller (120) controlling all of the SDN controllers (120) below it. In one example, the policy decisions made by each switch (105-1, 105-2, 105-3, 105-4) is controlled by the SDN controller (120) using, for example, OpenFlow or some other communications protocol that gives access to control the forwarding plane of any individual network switch (105-1, 105-2, 105-3, 105-4) or router (110) over the network (100). This allows a network administrator to provide a single point at which forwarding behavior and QoS policies may be implemented and propagated throughout the network (100) irrespective of the type or policy maker used by the device. OpenFlow is a protocol specification managed by the Open Networking Foundation (ONF) which is trade organization consortium of a number of member parties dedicated to promoting and adopting SDNs.

The router (110) may be any device that forwards data packets between networks. In the example shown in FIG. 1, the network (100) comprises a single router (110). However, the present application contemplates that any number of routers (110) may be used within the network (100). FIG. 1 shows, however, a situation where the router (110) provides access to a number of service providers (125) outside of the network (100). In this example, the router (110) creates a bottleneck where all data coming into and going out of the network (110) must pass through the router. In some examples, the router (110) connects the network (100) to the services (125) with a connection having a limited amount of bandwidth. Because of the cost of operating, for example, an internet service connection on the network (100), a business entity may find it difficult to increase the bandwidth capacity of this connection. As such, the connection between the router (110) and the services (125) may create a bottleneck during increased traffic scenarios. The connection between the router (110) and the service providers (125) may be conceptually realized as an enterprise edge (130). The enterprise edge (130) may be the demarcation point where the network (100) operated by one entity ends and services provided to the network (100) by another entity (125) are provided.

The number of end-points (115-1, 115-2, 115-3) may comprise any node of communication from which an individual user of the network (100) may gain access to the network and applications and services provided thereon. In one example, the end-point may be a computing device comprising a processor and a data storage device. In this example, the computing device may be capable of communicating with the network (110) in order to send emails, send data, engage in video or audio conferences, or combinations thereof. The end-points (115-1, 115-2, 115-3) may communicate with the network (100) either wirelessly or wired.

In another example, the end-point may be a telephone capable of communicating with the network (100) in order to, for example, deliver interactive voice communication and real-time multimedia calls over internet protocol (IP) such as VoIP. As described above, the network (100) may give preferential priority to each of these different types of communication by defining them as either a latency-sensitive data transfer or a non-latency-sensitive data transfer. Consequently, the SDN controller (120) may properly define the forwarding or routing behavior of the data packets sent by a specific application session on the end-points (115-1, 115-2, 115-3) in an efficient manner without degradation of the user experience in latency-sensitive communications.

The services (125) may comprise a connection to a wide area network (WAN), a connection to the Internet, a connection to a public switched telephone network (PSTN) trunk, or a wireless cellular network, among others, or combinations thereof. It is these services from which the users of the end-points (115-1, 115-2, 115-3) may wish to access through the router (110) and which may cause the bottleneck as described above.

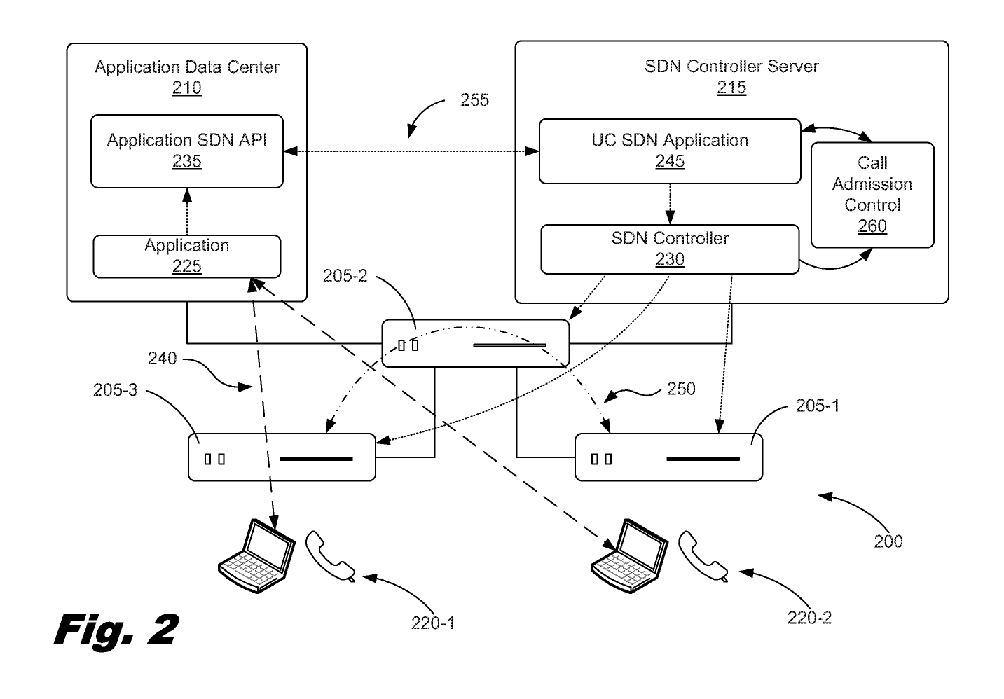

FIG. 2 is a block diagram showing a software-defined network system (200) according to one example of the principles described herein. FIG. 2 shows a similar network (FIG. 1, 100) as that shown in FIG. 1 with a number of switches (205-1, 205-2, 205-3) communicatively coupled to a number of end-points (220-1, 220-2). The network of the system (200) may be communicatively coupled to an application data center (210) and SDN controller server(s) (215). The application data center (210) may comprise a number of servers which facilitate a service. The service may be implemented using an application (225). The application may provide a third party service accessed by the user to, for example, provide real-time communication services under a unified communications scenario. Virtual desktops, thin clients, and other devices that would benefit from low latency traffic and good user experience would benefit from the use of the application (225). In one example, the application data center (210) could be running an application (225) such as Lync® and therefore provide those services to the user through the SDN controller (230). Lync® is a unified communications client that provides instant messaging services, voice and video conferencing using client software created by the Microsoft Corporation. It can be appreciated that Lync® is merely one example and a number of other services may be provided to the user of an end-point (FIG. 1, 115-1, 115-2, 115-3, 220-1, 220-2) using a number of different applications (225) operating in a number of application data centers (210). Still further, each of the application data centers (210) may be communicatively coupled to a number of SDN controller server(s) (215), each using a specific API such as the SDN application API (235) shown in FIG. 2. In one example, the number of SDN controllers (230) is one. In another example a plurality of SDN controllers (230) may exist and each may be communicatively coupled to the application data centers (210) based on geographic location of the SDN controller server(s) (215). In yet another example, the SDN controller (230) may control a number of subordinate SDN controllers based on geographic location of those subordinate controllers. In this example, the QoS policies and operation of the present systems and methods may be sent down to the subordinate controllers.

The communication between the application data center (210) and the SDN controller server(s) (215) allows for a single point of trust to be established in the network. Instead of relying on gaining trust from each end-point device (220-1, 220-2), trust need only be established between the application data center (210) with its application (225) and the SDN controller (230). In a network with thousands and sometimes hundreds of thousands of devices connected within the network, attempting to establish trust between each of the end-point devices (220-1, 220-2) would be difficult if not impossible to achieve. In this case, a single point of trust is established between the application data center (210) and a single version of an application SDN application protocol interface (API) (235) may be used to communicate with the SDN controller server(s) (215).

In FIG. 2, when a first end-point device (220-1) attempts to communicate with a second end-point device (220-2), a signal (240) may be sent to the application data center (210) and received by the application (225). The application (225) may decrypt the network traffic and know that the first end-point device (220-1) is attempting to communicate with the second end-point device (220-2). Additionally, the application (225) may further receive data describing what type of application is attempting to be run, the individual IP addresses associated with the end-point devices (220-1, 220-2), as well as how much bandwidth they require to run the application. It may therefore, receive logical information as described above, but may not know the physical network topology information regarding the first and second end-point devices (220-1, 220-2), such as the physical location of the devices within the network. The SDN controller (230), however, knows the physical topology of the network, but does not know what application type or network bandwidth requirements the first and second end-point devices (220-1, 220-2) are attempting to implement. After the signal (240) has been received the application (225) may, through the application SDN API (235), send the known data to the SDN controller (230). For example, this information may be received by a unified communication SDN application (245) which then forwards it onto the SDN controller (230). The information is used by the SDN controller (230) to determine what type of application is attempting to be run and program the individual switches (205-1, 205-2, 205-3) to assign a forwarding behavior, including level of QoS priority to the switches communicatively coupling the first and second end-point devices (220-1, 220-2). Since the network capacity may be shared by many users and different applications, the controller may choose to only allow an application to use a portion of the available capacity, based on administrative policy or calculated based on historical trends. Rather than allowing an application to attempt grabbing all the available bandwidth. After this is completed, the traffic flow (250) between the first and second end-point devices (220-1, 220-2) will be properly prioritized creating an improved peer-to-peer communication session between the two devices.

The system described in FIG. 1, therefore, allows a single SDN controller (230) to propagate forwarding behaviors and number of QoS polices to a number of switches (105-1, 105-2, 105-3, 105-4, 205-1, 205-2, 205-3) in the network (100) of the system (200). In addition to this, the system may engage in call admission control. Call admission control is a method that can be implemented by the SDN controller (230) that describes which sessions to reject or assign to a lower priority than other sessions. The system may also set rate limits to specific application sessions to protect the network and ensure that certain applications do not exceed a certain level of bandwidth. Still further, the system may allow for load balancing and policy-based routing (PBR) such that traffic may be directed out of the network based on certain policies. These policies may look at, for example, the cost of forwarding the data packets via a certain connection versus another connection; the hardware used to forward the data packet over either connection; and the time sensitive nature of the payloads associated with the data packets. Consequently, in some examples, the SDN controller (FIG. 2, 230) may generate policies based on the application data received by the application (225) via the application SDN API (FIG. 2, 235) to direct data packets to be routed by one router or over one network connection instead of another based on the cost of routing that data over that specific connection.

The application SDN API (235) may further be a bidirectional API. In this example, the system (200) may receive data from the application (225) on the application data center (210) via the application SDN API (235) as described above. This data comprises information regarding the end-point devices (220-1, 220-2) which are attempting to communicate, the IP addresses of the end-point devices (220-1, 220-2), and what type of application is attempting to be run in order to allow the end-point device (220-1, 220-2) to communicate. The application (225) and application data center (210) are not, however, provided with information as to the amount of traffic on the network within the system (200). The SDN controller (230) is aware of the traffic flow and may provide this information to the application (225) via the bidirectional API data link (255).

In some examples, the SDN controller (230) may assign a specific code point within a number of code points to a specific application or type of applications. This allows the SDN controller (230) to reserve a portion of the bandwidth to a specific type or specific application that is transmitting latency-sensitive data. The SDN controller (230), therefore, implements a call admission control (260) function that provides feedback to the application SDN API (235) and the application (225) regarding bandwidth capabilities of the network. The call admission controller (260) directs the UC SDN application (245) to return information to the application (225) regarding availability of bandwidth. In one example, a user may request a video conference with a second user of the network. Using a first end-point (220-1) device, the user may send a request to the application (225) with the necessary information to connect the two end-points (220-1, 220-2). The application (225) may send this request to the UC SDN application (245) through the application SDN API (235). The UC SDN application (245) may then request information from the call admission control (260) as to available bandwidth on the network. Where sufficient bandwidth is available for the video conference, the call admission control (260) will notify the SDN controller and the SDN controller will complete the connection by reserving bandwidth and setting the proper forwarding behavior for the videoconference. However, where insufficient bandwidth is available for a given traffic class of service, the call admission control (260) may direct the UC SDN application (245) to direct the application (235) to send the first end-point (220-1) a notification that resources are not available. The user of the first end-point device (220-1) may see on a user interface associated with the first end-point device (220-1) the notification. This prevents all users of the application running with active sessions for a specific class of service from having a poor experience while transmitting their respective latency-sensitive data across the network.

In another example, the call admission control (260) may allow an additional latency-sensitive service onto the network, but will direct the application to dynamically adjust all, or some of the current latency-sensitive services to run at a higher compression rate in order to reduce the bandwidth usage. In some examples, adjusting to a higher compression of the latency-sensitive data may be unnoticeable to the other users of the system (200) and will provide higher scalability of concurrent sessions that can be supported at, for example, during peak usage hours or occasional periods of unexpected high demand for a given service. This may allow the system (200) to provide both a higher quality of experience when a low number of concurrent sessions are active, while also allowing for higher scalability of services in a dynamic manner due to some or all of the services being more compressed in order to support additional users or additional services on the network, or combinations thereof.

In yet another example, the call admission control (260) may allow a user to determine whether the session can be done at a higher compression rate, with reduced functionality, or not allow the session to proceed. In this example, the call admission controller (260) may provide the application (235) with information as to the current available bandwidth and the application may return the above mentioned options to the user via an interface selection. In this example, the user may simply wait until a later time to get a higher quality videoconference call, accept a videoconference call with a higher compression rate, or elect to make on an audio call without any video. This also allows for all other users of the system (200) engaging in similar latency-sensitive data transfers to be minimally affected by the addition of the user's videoconference call on the network. The policies directing the call admission control (260) to provide the application with the above mentioned options to the user of the end-point (220-1) device may be dictated by the administrative policies configured on the SDN controller.

In some examples, the SDN controller may partition out the available bandwidth such that different types or classes of data packets have a predefined amount of bandwidth provisioned to them. For example, if the total available bandwidth was 10 megabytes, ⅓^{rd} of that may be reserved for video conferencing associated data packets, ⅓^{rd} may be reserved for voice communications, and the rest may be available for all other types of data packets being transmitted. The SDN controller (230) with the call admission control (260) may then be able to communicate to the application in the data center (210) such that the application may be limited, if necessary, to the QoS policies dictated by the SDN controller and the currently available bandwidth for that type or class of data packet transmission.

The system (200) shown in FIG. 2 is merely an example of the physical layout of the system (200) and the present application contemplates other physical layouts. In one example, the SDN controller (230) may be only enabled at certain access switches (205-1, 205-3) instead of the entire number of switches within a network. In this example, the access switches (205-1, 205-3) may be the only switches that the SDN controller (230) applies the policies to in order to provide more efficiency.

In another example, the SDN controller (230) may only be enabled for a certain number or kind of applications. In this example, an administrator of the network may have the SDN controller (230) only apply its policies when certain applications (225) are run. In this example, all other data packets originating from all other types of applications would be transmitted as a “best effort” regime such that all other applications would be given whatever bandwidth is available after the SDN controller (230) controlled applications have been partitioned the appropriate amount of bandwidth.

Additionally, although FIG. 2 shows a number of switches in which the SDN controller (230) applies policies to, the present application further contemplates a system in which the SDN controller (230) manages other types of nodes within the network. In one example, a router may also be managed by the SDN controller (230) such that the router may route data packets based on the policies of the SDN controller (230). In this case, the SDN controller (230) may allow routing of data packets on a per-session basis such that when a session is made, a port may be opened for that specific source and destination pair. This may prevent others from receiving access to the network through previously unsecured ports. The knowledge about the application information sent to the SDN controller (230) from the application (225) may be used to provide better secure firewalls in a dynamic manner such that certain port numbers are not left open all the time and instead are only opened for the duration of a session and on a session-by-session basis.

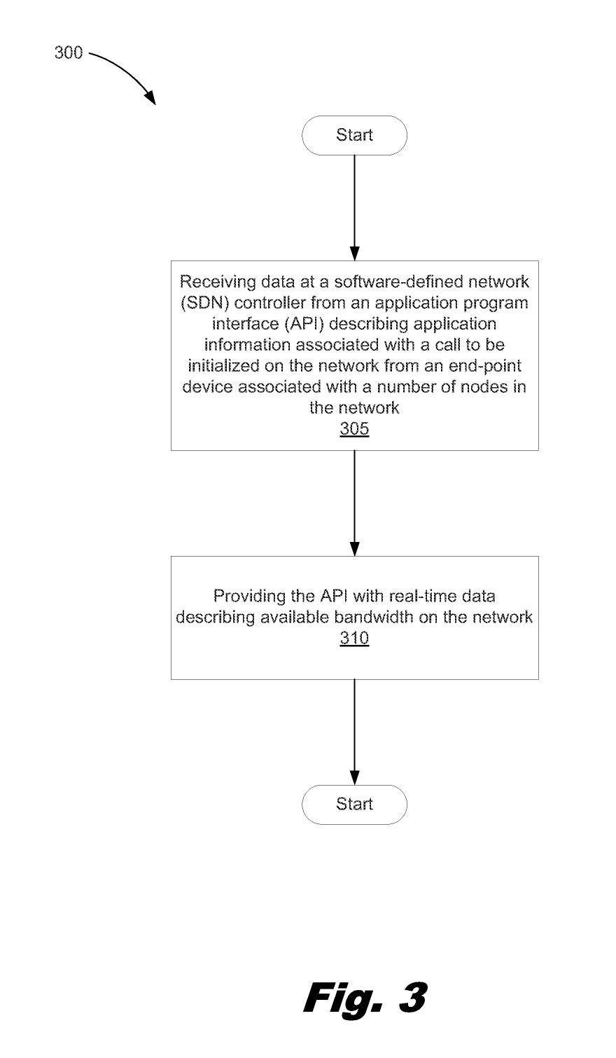

FIG. 3 is a flowchart showing a method (300) of provisioning a network for network traffic according to one example of principles described herein. The method (300) may begin with the SDN controller (FIG. 2, 230) receiving (305) data from an application program interface (API) describing application information associated with a session to be initiated on the network from an end-point device associated with a number of nodes in the network. As described above, the data received by the SDN controller (FIG. 2, 230) may comprise information about the end-point devices (FIG. 2, 220-1, 220-2) to be communicated and the application by which they intend to communicate with. The application (FIG. 2, 225) used to communicate with may be any type of application and an associated the associated application SDN API (FIG. 2, 235) may be used to communicate this data to the SDN controller (FIG. 2, 230).

The method (300) may continue with the SDN controller (FIG. 2, 230) providing (310) the application SDN API (FIG. 2, 235) with real-time data describing available bandwidth on the network. In one example, if the network bandwidth is currently unavailable, the API may forward to the application (FIG. 2, 225) a message from the SDN controller (FIG. 2, 230) indicating that services are currently not available and that the user of the end-point devices (FIG. 2, 220-1, 220-2) should attempt a session at a later time. If there is some, but only a limited amount of bandwidth, the API may forward to the application (FIG. 2, 225) a message from the SDN controller (FIG. 2, 230) indicating that services are currently low and that, for example, in the case of video conferencing, the compression rate will be increased in order to allow the session to continue. The user of the end-point devices (FIG. 2, 220-1, 220-2) may then choose to move forward with the video conference at the lower compression rate, select an audio only conference, or wait till a later time when the network traffic is lower and proceed with a higher quality session at a lower compression rate.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, a processor or other programmable data processing apparatus, implement the functions or acts specified in the flowchart and/or block diagram block or blocks. In one example, the computer usable program code may be embodied within a computer readable storage medium; the computer readable storage medium being part of the computer program product.

The computer readable storage medium may comprise computer usable program code to, when executed by a processor, receive data at a software-defined network (SDN) controller from an application program interface (API) describing application information associated with a session to be initiated on the network from an end-point device associated with a number of nodes in the network. The computer readable storage medium may further comprise computer usable program code to, when executed by a processor, provide the API with real-time data describing available bandwidth on the network.

The specification and figures describe a network system and method of provisioning a network for network traffic. The system and method alleviate the need for devices on the network to perform packet inspection for each data packet being transferred on the network. This is because the API associated with the application data center may transmit specific data describing the specific session characteristics of the application being accessed by the end-point device. Still further, the SDN controller provides a user friendly and more scalable environment by which policies need not be manually configured by a network administrator on every access switch or node in the network in order to derive what the new session communication needs are. The application information can be used for a number of network policy purposes including, but not limited to, quality of service provisioning, call admission control, rate-limiting, load balancing, policy based routing (PBR), least-cost routing, security, firewall traversal, and wireless roaming policy. The system further provides for a bi-directional flow of information between the SDN controller and the application such that the application does not assume as to what the network conditions are and any corrective action can be coordinated between the application and the network. The system and method also allows for the application to use networking information or feedback to configure the application session parameters to improve the user experience and/or more effectively utilize networking resources.

The preceding description has been presented to illustrate and describe examples of the principles described. This description is not intended to be exhaustive or to limit these principles to any precise form disclosed. Many modifications and variations are possible in light of the above teaching.

What is claimed is:

1. A network system comprising:
a software-defined network (SDN) controller; and
an application program interface (API) communicatively coupled to an application and the SDN controller;
in which data is provided from the API to the SDN controller, the data comprising information regarding the application session characteristics associated with a new session to be initiated on the network.

2. The network system of claim 1, in which the data provided from the API is received from a third party application in response to a session request from an end-point computing device within the network.

3. The network system of claim 1, in which, in response to receiving the data, the SDN controller provides the API with real-time data describing available bandwidth on the network that the application may use.

4. The network system of claim 1, in which the SDN controller and the application program interface are communicatively coupled using a trusted connection.

5. The network system of claim 1, in which the SDN controller applies policies to a number of nodes within the network and reserves bandwidth for an application session to the nodes when the session is initiated.

6. The network system of claim 5, in which at least one of the number of nodes is a router, a firewall or security device, and in which the SDN controller directs the router, firewall or other security device to route data packets associated with the session on a per-call basis such that a port on the router, firewall or security device is not open until the session is initiated.

7. The network system of claim 1, in which the SDN controller applies policies to a number of nodes within the network and in which the policies comprise:
a load balancing policy,
a wireless roaming policy,
a routing policy,
a quality of service (QoS) policy;
a rate limiting policy;
or combinations thereof.

8. The network system of claim 1, in which the data provided from the API to the SDN controller comprises:
the IP address of a first and second node within a number of nodes that are attempting to communicate;
what type of application is attempting to be run;
how much bandwidth is required to run the application; or
combinations thereof.

9. A method of provisioning a network for network traffic comprising:
receiving data at a software-defined network (SDN) controller from an application program interface (API) describing application information associated with a session to be initiated on the network from an end-point device associated with a number of nodes in the network; and
providing the API with real-time data describing available bandwidth on the network that the application may use.

10. The method of claim 9, in which the SDN controller and the application program interface are communicatively coupled using a trusted connection.

11. The method of claim 9, in which the SDN controller applies policies to the number of nodes within the network and reserves bandwidth for an application session to the nodes when the session is initiated.

12. The method of claim 9, in which at least one of the number of nodes is a router, a firewall, or a security device and in which the SDN controller directs the router, the firewall, or the security device to route data packets associated with the session on a per-call basis such that a port on the router, firewall, or security device is not open until the session is initiated.

13. A computer program product for provisioning a network for network traffic, the computer program product comprising:
a computer readable storage medium comprising computer usable program code embodied therewith, the computer usable program code comprising:
computer usable program code to, when executed by a processor, receive data at a software-defined network (SDN) controller from an application program interface (API) describing application information associated with a session to be initiated on the network from an end-point device associated with a number of nodes in the network; and
computer usable program code to, when executed by a processor, provide the API with real-time data describing available bandwidth on the network that the application may use.

14. The computer program product of claim 13, in which at least one of the number of nodes is a router, a firewall, or security device and in which the computer program product further comprises computer usable program code to, when executed by a processor, direct, via the SDN controller, the router, firewall, or security device to route data packets associated with the session on a per-call basis such that a port on the router, firewall, or security device is not open until the session is initiated.

15. The computer program product of claim 13, in which the data provided from the API is received from a third party application in response to a session request from an end-point computing device within the network.
